(19) United States
(12) Patent Application Publication
(10) Pub. No.: US 2008/0302151 A1
(43) Pub. Date: Dec. 11, 2008

(54) Soluble Liquid Fertilizer for Organic Agriculture Derived From Soy Meal

(76) Inventor: Timothy Allan Stemwedel, Fresno, CA (US)

Correspondence Address: Timothy Allan Stemwedel, Suite 121, 7600 N. Ingram Ave., Fresno, CA, 93711, US

(21) Appl. No.: 11/761,302

(22) Filed: Jun. 11, 2007

(51) Int. Cl. C05F 11/00

(52) U.S. Cl. 71/23

(57) ABSTRACT

The invention is a water-soluble, liquid or dry fertilizer for application to a plant or soil that is grown or farmed as “organic” as defined under the USDA National Organic Program Rule. The fertilizer is produced from soybean meal using protolytic enzyme (protease) hydrolysis to produce water-soluble, Nitrogen-containing compounds including protein, peptides, amino acids, amines and ammonia. The fertilizer also contains other essential plant nutrients including Calcium, Phosphorus, Sulfur and Potassium. The fertilizer has solids content between ten and fifty-five percent, and a total Nitrogen content between 1.0 percent and 10 percent.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Using soybean meal to produce fertilizer increases the consumption of soybean meal. The organic agriculture market is in need of additional Nitrogen-containing fertilizer products. The increased use of soy beans to produce bio-diesel increases the amount of soybean meal available for use in the manufacture of other products. Soybeans do not require Nitrogen-fertilization for growth since they are a Nitrogen-fixing legume. Fertilizers produced from soybeans do not require large amounts of energy to produce. The fertilizer of this invention reduces demand for fossil fuel-produced fertilizer.

1. Field of Invention

This invention relates, in general, to fertilizers for providing nutrients to plants, and, in particular, applies to fertilizers for “organic production” as defined in the Code of Federal Regulations Title 7, Part 205, Section 205.2.

2. Description of Related Art

Organic production does not allow for the use of chemically processed or derived fertilizers commonly used in conventional agriculture. Some examples of these fertilizers are Urea, Ammonia, Ammonium Nitrate, Phosphoric Acid, Ammonium Phosphate compounds, and Calcium Nitrate. Materials that are allowed in organic production must be natural, organic materials or raw, mined minerals with few exceptions.

Currently, organic farms use the following materials for fertilization of the crops:
Compost derived from animal waste or other materials allowed by the National Organic Program Rule,
Fresh plant material from incorporating a Nitrogen-fixing crop into the soil,
Raw animal manures (not sewage sludge),
Animal or plant materials which include fish meal, blood meal, feather meal, soybean meal, and other high protein containing materials.

Plant or animal protein materials are commonly used in organic production since protein is a Nitrogen-containing compound. In general, every kilogram of protein contains approximately 160 grams of Nitrogen. Protein Nitrogen when applied to the soil requires biological decomposition into a form useable by plants. Protein by-products from rendered animals contain between 50 and 85 percent protein, as well as other essential elements required by plants such as Phosphorus, Calcium, Potassium and Iron. These protein products are used in powder or pellet form, as offered by California Organic Fertilizers, Inc. These fertilizer products contain between 4% and 12% Nitrogen. California Organic Fertilizers, Inc. has been successful in marketing these products for organic production for 17 years.

There are many benefits to using natural organic materials as a source of fertilizers. These products are generally by-products of other agricultural industries. They are low in salts, so they do not pose a hazard relative to irrigation or rainfall run-off. The low salt level also aids in improving the quality of the soil. The low nitrate formation of these products also produces food with lower nitrates. They are not manufactured using fossil fuel. These products are not soluble salts so they do not leach easily into ground water aquifers.

Prior Art

Prior fertilizer development efforts failed to appreciate the value of soy isolates and hydrolysates as a fertilizer for organic production. In addition, prior development efforts failed to consider the further processing of these materials using enzyme hydrolysis to produce water-soluble Nitrogen-containing fertilizers. There are many inventors who have used enzymes to further process soy into hydrolysates or isolates for use in food or industrial products. None of the inventors retained the hydrolysates or isolates as soluble material for use as a soluble Nitrogen fertilizer.

U.S. Pat. No. 6,406,511

Filing date: Jun. 11, 2001

Issue date: Jun. 18, 2002

Inventors: Haim B. Gunner, William A. Torello, Ming-Jung Coler

Assignee: EcoOrganics, Inc.

Primary Examiner: Chhaya D. Sayala

Attorney: Malcolm J. Chisholm, Jr.

Gunner, et al., failed to recognize that soy proteins, also referred to as soy isolates, may be rendered soluble and degraded into other soluble compounds using enzyme hydrolysis. Their patent covers the use of fine ground denatured soybean particles as a fertilizer which requires microbial decomposition in order to render the Nitrogen absorbable by the plant. They also failed to consider their invention useable for organic agriculture.

U.S. Pat. No. 4,618,670

Filing date: Mar. 19, 1985

Issue date: Oct. 21, 1986

Inventor: Giorgio Colmelet

Assignee: Novavis Intercontinental, Ltd.

Colmelet, in March of 1985, uses soy meal to produce soluble proteins and amino acids from acid hydrolysis for use in insect control but fails to discover the use of enzymes and the use of the soluble proteins and amino acids as a fertilizer.

U.S. Pat. No. 6,177,072

Filing date: Jun. 10, 1998

Issue date: Jan. 23, 2001

Inventors: Sadik Tuzun, Ismail Alp

Primary Examiner: Frank Choi

Tuzun, et al. uses various enzymes to produce soy protein hydrolysates for use as insecticides and insect attractants but fails to discover the use of soy protein hydrolysates as a fertilizer.

U.S. Pat. No. 4,491,464

Filing date: May 17, 1983

Issue date: Jan. 1, 1985

Inventors: Harvey H. Ashmead, Hsin-Hung Hsu

Ashmead and Hsu make the following claims in their patent:

“The effectiveness of a potassium polyphosphate fertilizer is enhanced resulting in higher intake of phosphorus and potassium into plant tissues and higher crop yields by the foliar application to growing plants of a composition comprising a blend of potassium and ammonium polyphosphates which also contains an effective amount of a protein hydrolysate.
1. A liquid fertilizer composition suitable for dilution and application as a foliar spray comprising a blend of potassium and ammonium polyphosphates containing from about 0.5% to 3.0% by weight of a protein hydrolysate wherein the ratio of the polyphosphate blend to protein hydrolysate is between 200:1 to 20:1.
2. A liquid fertilizer composition according to claim 1 wherein the protein hydrolysate is a mixture of polypeptides, dipeptides and naturally occurring amino acids resulting from the hydrolysis of intact proteins.
3. A liquid fertilizer composition according to claim 2 wherein the intact protein is a plant protein.
4. A liquid fertilizer composition according to claim 2 containing from about 2% to 5% nitrogen, 15% to 19% P.sub.2 O.sub.5 and 15% to 19% K.sub.2 O.
5. A method according to claim 4 wherein the liquid concentrate, prior to dilution, contains from about 2% to 5% nitrogen, 15% to 19% P.sub.2 O.sub.5 and 15% to 19% K.sub.2 O.
6. A method of increasing the phosphorus and potassium content of plant tissues which comprises applying to living immature plant tissues, as a foliar spray, an aqueous composition prepared by diluting a liquid concentrate comprising a blend of potassium and ammonium polyphosphates containing from about 0.5% to 3.0% by weight of a protein hydrolysate wherein the ratio of polyphosphate blend to protein hydrolysate is between about 200:1 to 20:1 with water at a dilution ratio of 5 to 200.
7. A method according to claim 6 wherein the protein hydrolysate is a mixture of polypeptides, dipeptides and naturally occurring amino acids resulting from the hydrolysis of intact protein.
8. A method according to claim 7 wherein the intact protein is a plant protein.”

They fail to find value in the protein hydrolysates as a Nitrogen fertilizer and additionally as a solely-applied plant Nitrogen nutrient. They also fail to place value on the hydrolysates as a fertilizer for organic agriculture. Their claims are for the use of protein hydrolysates to improve the efficacy of potassium and ammonium polyphosphates and not as a source of Nitrogen. Additionally, their data showed that the combination of the protein hydrolysates and the polyphosphates did not increase Nitrogen content in plants.

U.S. Pat. No. 5,290,749

Filing date: Aug. 3, 1993

Issue date: Mar. 1, 1994

Inventors: Nick E. Christians, John T. Garbutt, Dianna Liu

Assignees: Iowa State University Research Foundation, Inc., Grain Processing Corporation

Christians, Garbutt, and Liu found the following:

“A method of selectively inhibiting growth of unwanted plants in a plot of soil is provided comprising the application of a plant protein hydrolysate to the plot of soil, prior to emergence of the unwanted plants and at a concentration of application which inhibits the growth of the unwanted plants.

The above invention fails to recognize the value of protein hydrolysate as a Nitrogen fertilizer for use in agriculture and organic agriculture. The invention above is also specific to the use of corn gluten protein hydrolysate and disregards the use of other types of proteins.

U.S. Pat. No. 6,896,917

Filing date: Mar. 19, 2001

Issue date: May 24, 2005

Inventors: Appu Rao Gopala Rao Appu Rao, Hole Narasipura Nanjundaiah Chandrasekhara, Karadka Govindaraju, Johny Joseph, Kolara Subramanyam Krishna Murthy, Vishweshwariah Prakash, Mysore Cheeluvaraya Shamanthaka Sastry

Assignee: Council of Scientific & Industrial Research

Rao, et al. has the following invention:

“A process for preparation of protein hydrolysate from soy flour. The process comprises the steps of hydrolyzing an aqueous slurry of defatted soy flour containing 6-30% solid content w/v using protolytic enzyme of plant origin at a pH of 5-9 and at a temperature of 53±5° C. under stirring for 30 minutes to 6 hours; inactivating the enzyme by a known manner, neutralizing the pH value of the slurry, separating the solids by a known manner, and drying the clarified liquor so obtained to get the hydrolysate.

Rao, et al. invented a process to produce dry protein hydrolysate from soy flour but failed to recognize the use of soluble protein hydrolysate as a fertilizer.

U.S. Pat. No. 5,077,062

Filing date: May 3, 1990

Issue date: Dec. 31, 1991

Inventor: John H. Ernster

Assignee: Excelpro Inc.

Ernster states the following:

“A low sodium, low monosodium glutamate soy hydrolysate is prepared from a soy material, as for instance, soy flour, soy meal or soy grits by hydrolyzing the soy material with a protease enzyme in water. The hydrolysis is conducted in the absence of the addition of either acid or base at a temperature of about 90.degree. for 2 hours. After deactivating the enzyme and dewatering the mixture the resulting hydrolysate contains from about 45 to about 55 weight percent of enzymatic hydrolyzed soy based protein, from about 1 to about 3 weight percent fat, from about 5 to about 9 weight percent ash, from about 2 to about 8 weight percent water, from about 32 to about 36 weight percent carbohydrate, and less than 0.1 weight percent sodium.”

Although Ernster recognized the use of enzymes to hydrolyze soy material, he failed to recognize the use of enzymes to produce a soluble hydrolysate fertilizer.

### BRIEF SUMMARY OF THE INVENTION

The invention is a soluble liquid or dry fertilizer for application to a plant or soil that is grown or farmed as “organic” as defined under the USDA National Organic Program Rule. The fertilizer is produced from soybean meal, a co-product from soy oil production. The fertilizer is produced by protolytic enzyme (protease) hydrolysis to reduce proteins to small-size, water-soluble, Nitrogen-containing compounds including protein, peptides, amino acids, amines and ammonia. The fertilizer has a solids content between five and ninety-five percent, a total Nitrogen content between one and thirteen percent.

### BRIEF DESCRIPTION OF THE SEVERL VIEWS OF THE DRAWING

Not Applicable

### DETAILED DESCRIPTION OF THE INVENTION

Soybean meal is a co-product of soy vegetable oil production.

The fertilizer of claim 1 is processed by protolytic enzyme (protease) hydrolysis to produce smaller-size, water-soluble, Nitrogen-containing compounds including protein, peptides, amino acids, amines and ammonia. This is achieved by mixing soybean meal, water and enzymes and allowing the enzymes to hydrolyze the proteins in the soybean meal.

The proteins in claim 1 are hydrolyzed using protolytic enzymes (Proteases) such as papain, bromelain, pepsin, trypsin or other protease enzymes, separate or in combination, at a rate which will hydrolyze between 25 percent and 90 percent of the proteins.

The insoluble solids are removed from the water/soy/enzyme mixture and concentrated. Concentration may be achieved by using equipment such as evaporators, spray dryers, or membrane filters.

The resulting fertilizer has the following characteristics:
a. The fertilizer has a solids content between 10 to 65 percent solids on a weight to weight basis;
b. The fertilizer has a total Nitrogen content between 1.0 and 13 percent on a weight to weight basis;
c. The fertilizer has a final pH of between 4.5 and 10. The pH of the fertilizer increases as the enzymes hydrolyze the protein;
d. The fertilizer may be dried into a soluble solid;
e. The fertilizer is stable at normal environmental temperatures and requires no special handling.

Following, is a characteristic example of the nutrient content on an “as-is” weight to weight basis of a fertilizer produced using this invention:

| | |
|---|---|
| Total Nitrogen | 6.00% w/w |
| Water Soluble Nitrogen | 5.90% w/w |

The analysis will vary depending upon the concentration of the fertilizer.

1. A soluble liquid fertilizer for application to a plant or soil that is grown conventionally or farmed as “organic” as defined Under the USDA National Organic Program Rule comprising:
a. Soluble protein derived from enzyme hydrolyzed soybean meal;
b. Wherein the existing proteins may be further degraded into smaller sized, soluble molecules, including polypeptides, amino acids, amines and ammonia;
c. Wherein the proteins are hydrolyzed using protolytic enzymes (Proteases) such as papain, bromelain, pepsin, trypsin or other protease enzymes;
d. Wherein the liquid fertilizer described may be dried into a water soluble solid fertilizer.

2. The liquid fertilizer described in claim one, which additionally has the following characteristics:
f. Wherein the liquid fertilizer has a solids content between 10 to 65 percent solids on a weight to weight basis;
g. wherein the liquid fertilizer has a water content between 35 and 90 percent on a weight to weight basis;
h. wherein the liquid fertilizer has a Nitrogen content between 1 and 13 percent on a weight to weight basis;
i. wherein the liquid fertilizer has a final pH of between 4.5 and 10.0;
j. Wherein the liquid fertilizer described may be dried into a water soluble solid fertilizer.
